(19) United States
(12) Patent Application Publication
(10) Pub. No.: US 2017/0004503 A1
(43) Pub. Date: Jan. 5, 2017

(54) Personal Identification Number at Account Level

(71) Applicant: Rattaya C. Yalamanchili, Houston, TX (US)

(72) Inventor: Rattaya C. Yalamanchili, Houston, TX (US)

(73) Assignee: YALAMANCHILI AMERICAS, INC., Houston, TX (US)

(21) Appl. No.: 14/008,588

(22) PCT Filed: Mar. 28, 2012
(86) PCT No.: PCT/US12/30830

§ 371 Date: Nov. 18, 2015

Related U.S. Application Data
(60) Provisional application No. 61/468,107, filed on Mar. 28, 2011.

(51) Int. Cl. G06Q 20/40

(52) U.S. Cl. CPC G06Q 20/4012; G06F 21/31

(57) ABSTRACT

A system and method provide access to financial accounts. In one embodiment, a PIN at account level system includes a PIN assigned to a financial account. The PIN is different from a PIN of another financial account. The PIN at account level system further includes allowing access to the financial account by confirmation of the PIN assigned to the financial account when the PIN is provided.

### BACKGROUND OF THE INVENTION

Field of the Invention

This invention relates to the field of financial accounts and more specifically to personal identification numbers at the account level for financial accounts.

Background of the Invention

Personal identification numbers (PINs) have been increasingly used for financial transactions as safety and privacy mechanisms. PINs are typically used to authenticate users to a system. For instance, a user provides a PIN to obtain access to the system. Upon the user providing the PIN, the system will compare the provided PIN to the matching PIN for the user stored on the system. The user will obtain access to the system upon confirmation of the PIN by the system.

PINs have been conventionally used with debit cards, pre-paid cards, and credit cards. Typically, the PIN may be issued at a card level and assigned to a particular card. For instance, each card that is issued has a PIN. Each card may be linked to one or more accounts, with the PIN providing access via the card to each of the accounts. Drawbacks include access by a user of the card to each of the linked accounts. Further drawbacks include a user of the account having access to account totals in all linked accounts.

Consequently, there is a need for an improved PIN system for financial accounts.

### BRIEF SUMMARY OF SOME OF THE PREFERRED EMBODIMENTS

These and other needs in the art are addressed in one embodiment by a PIN at account level system that includes a PIN assigned to a financial account. The PIN is different from a PIN of another financial account. The PIN at account level system further includes allowing access to the financial account by confirmation of the PIN assigned to the financial account when the PIN is provided.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of the PIN at account level system in which the card is a combi-card and has multiple PINs;

FIG. 2 illustrates an embodiment of the PIN at account level system of FIG. 1 in which one of the accounts is accessible by two PINs;

FIG. 3 illustrates an embodiment of the PIN at account level system in which a card has a PIN providing the true balance of an account and a PIN providing a different balance of the account;

FIG. 4 illustrates an embodiment of the PIN at account level system in which a card has a PIN providing the true balance of an account, a PIN providing a different balance of the account, and a PIN providing a signal;

FIG. 5 illustrates an embodiment of the PIN at account level system in which an account has multiple PINs with each PIN having restrictions; and

FIG. 6 illustrates an embodiment of the PIN at account level system in which a card has multiple card copies.

### DETAILED DESCRIPTION OF THE PREFERRED EMBODIMENTS

In an embodiment, a personal identification number (PIN) at account level system includes issuing a PIN at an account level. It is to be understood that the PIN is not issued at the card level but instead at the account level. Account level refers to a financial account such as an account at a financial institution (i.e., bank) that allows money to be earned, deposited, transferred, withdrawn and the like by a user such as the account holder or someone authorized by the account holder. Without limitation, financial accounts include checking accounts, savings accounts, individual retirement accounts, loyalty point systems, frequent flyer accounts, reward point systems, and the like. Personal identification number (PIN) refers to a password that may be shared between a user and the system and that may be used for authenticating the user to the system. In embodiments, each financial account has a PIN. In an embodiment, to access a financial account, a user uses the PIN assigned to the financial account, and the system authenticates the PIN. In embodiments, the PIN includes any combination of numbers, letters, punctuation marks, symbols, or any combinations thereof. In an embodiment, the PIN is an alphanumeric password. The alphanumeric password comprises any combination of letters and numbers.

In embodiments, the PIN at account level system includes cards linked to the financial accounts. The card may include any suitable type of financial card. For instance, without limitation, examples of suitable cards include credit cards, debit cards, cash cards, charge cards, pre-paid cards, and automated teller machine (ATM) cards. The cards may be physical cards or virtual cards. A virtual card refers to a physical network card for which an abstraction layer has been created, which allows more than one virtual machine to share the card.

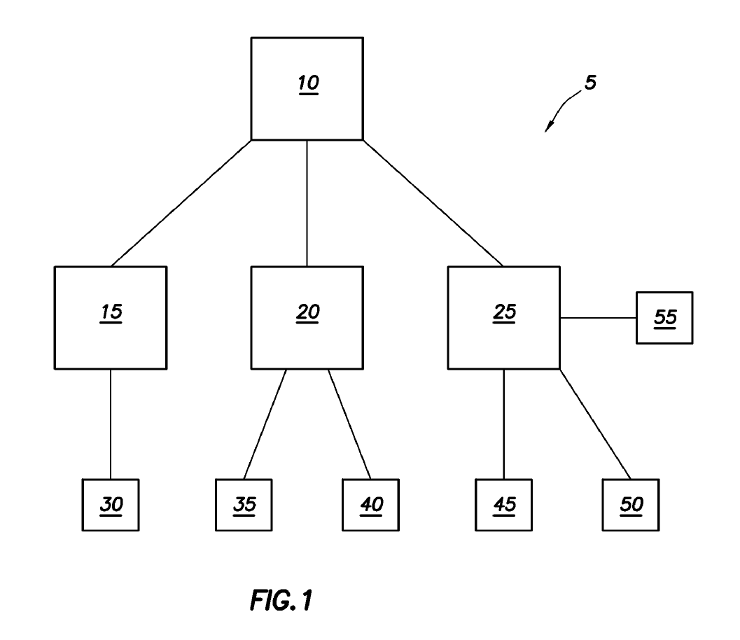

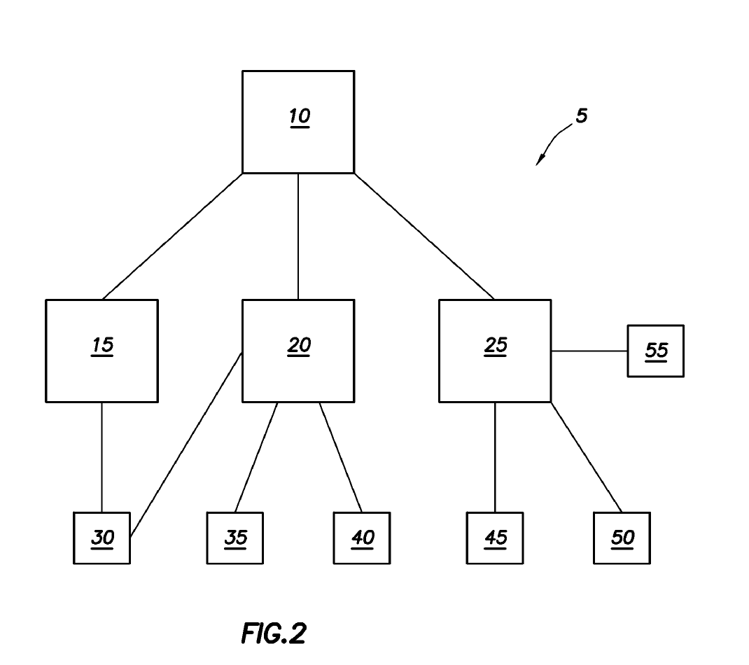

Embodiments include the PIN at account level system having a card that is a combi-card. In some embodiments, the PIN at account level system includes more than one combi-card. A combi-card refers to a card linked to more then one financial account. In embodiments, the combi-card is linked to more than one type of financial account. For instance, the combi-card may be linked to a debit account and a credit account. In an embodiment, each financial account has a PIN different from the PIN of the other financial account or accounts. In embodiments, based on the PIN used through the card, the corresponding financial account linked to the PIN may be accessed and transacted upon. In some embodiments, each PIN may provide access to one or more than one different financial account. FIG. 1 illustrates an embodiment of PIN at account level system 5 in which PIN at account level system 5 has card 10, which is a combi-card. In such an embodiment, card 10 has first PIN 15, second PIN 20, and third PIN 25. It is to be understood that FIG. 1 shows PIN at account level system 5 having three PINs (e.g., first PIN 15, second PIN 20, and third PIN 25) for illustrative purposes only and in alternative embodiments, PIN at account level system 5 may have any number of PINs (i.e., one or more than one PIN). In embodiments as shown, first PIN 15 provides access to account 30; second PIN 20 provides access to account 35 and account 40; and third PIN 25 provides access to account 45, account 50, and account 55. In embodiments, access to additional accounts may be added to first PIN 15, second PIN 20, and/or third PIN 25. In other embodiments, access to accounts may be removed from first PIN 15, second PIN 20, and third PIN 25. In some embodiments as shown in FIG. 2, PIN at account level system 5 includes one or more of the PINs each having access to one or more than one of the same accounts. As shown, first PIN 15 and second PIN 20 each have access to account 30.

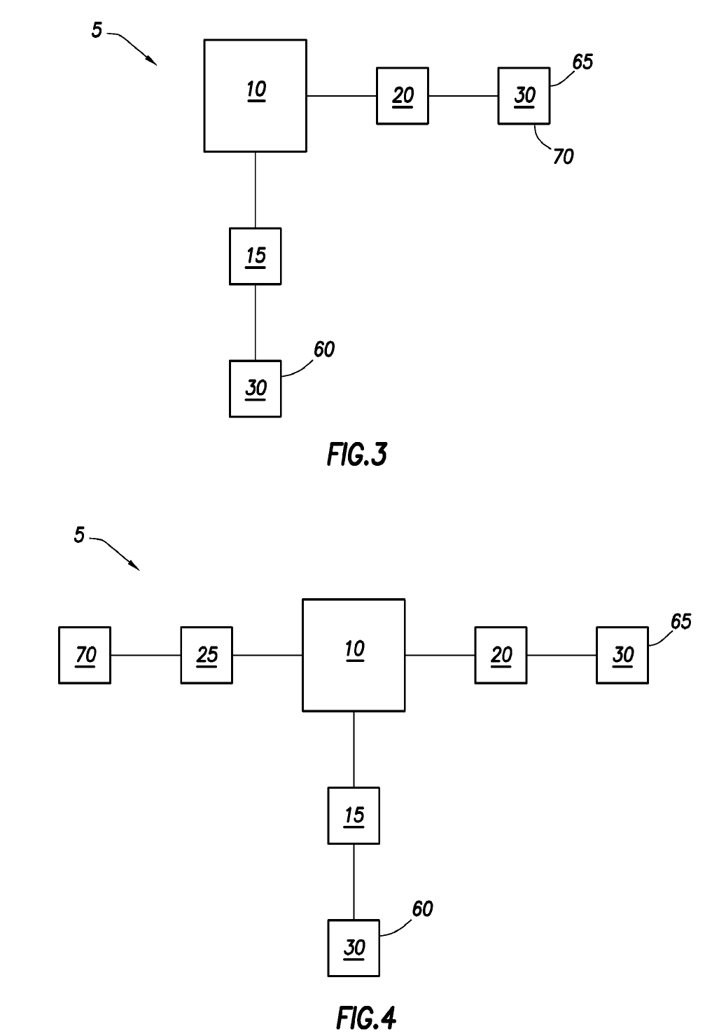

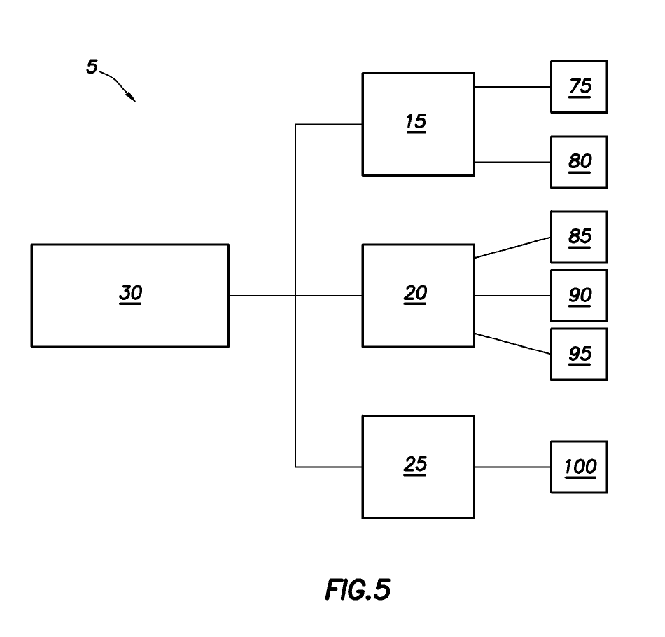

In an embodiment, PIN at account level system 5 may include an account holder having two PINs assigned to a single financial account, which is linked to a card. In an embodiment, one of the PINs may provide the true balance for the financial account (i.e., the current balance). The other PIN may provide a different balance from that of the true balance. In an embodiment, the different balance is zero or a value greater than zero but different from that of the true balance. In embodiments, the different balance is defined by the account holder. In an embodiment, PIN at account level system 5 includes a separate PIN from the PIN having the true balance with the separate PIN providing a duress signal indicating access by the account holder to the account is under duress. In some embodiments, such signal may be notified to law enforcement authorities. FIG. 3 illustrates an embodiment of PIN at account level system 5 in which account 30 has first PIN 15 associated with card 10. In such an embodiment, first PIN 15 provides access to true balance 60 of account 30. PIN at account level system 5 also has second PIN 20 that provides access to different balance 65 of account 30 but does not provide access to true balance 60. In some embodiments, second PIN 20 also sends signal 70 that the user is under duress. FIG. 4 illustrates an embodiment of PIN at account level system 5 in which account 30 has first PIN 15 associated with card 10. In such an embodiment, first PIN 15 provides access to true balance 60 of account 30. PIN at account level system 5 also has account 30 having second PIN 20 that provides access to different balance 65 of account 30 but does not provide access to true balance 60. PIN at account level system 5 also has third PIN 25 that does not provide access to account 30. Instead, third PIN 25 sends signal 70 that the user is under duress. Without limitation, an advantage of such embodiments includes facilitating a user in countries in which crime is high and which the user may be unwillingly forced to disclose a PIN or in which the user may be in duress.

In embodiments, PIN at account level system 5 has more than one PIN assigned to an account. Each PIN assigned to a financial account has different functions. In embodiments, each PIN may have a different transaction limit. In some embodiments, a PIN may only allow access to a financial account but no ability to remove funds from the financial account (i.e., the user may only be able to view the balance), with another PIN allowing funds to be removed from the account. In some embodiments, one or more than one of the PINs may have restrictions. In embodiments, restrictions include daily withdrawal limits, maximum point of sale limits, maximum daily limits, maximum withdrawal and/or point of sale limits over a period of time, location limits, item limits, time termination limits, access termination limits, incorrect PIN termination limits, or any combinations thereof. The daily withdrawal limits include a maximum amount of cash allowed to be withdrawn per day. The maximum point of sale limits may include a maximum amount that may be withdrawn at a point of sale. It is to be understood that point of sale refers to the location at which a sale occurs. The maximum daily limits include the maximum amount withdrawn in a day. Such maximum amount withdrawn in a day includes the total amount of cash withdrawn, the total amount of point of sale transactions, or any combinations thereof. The maximum withdrawal and/or point of sale limits over a period of time include any desirable period of time. In embodiments, the period of time includes a total amount allowed over a period of days, a total amount allowed in a week, a total amount allowed over multiple weeks, a total amount allowed over a month, a total amount allowed over a quarter, a total amount allowed over a year, or any combinations thereof. Location limits include restricting access to the account in only certain locations. The locations may be geographical locations (i.e., cities, countries, and the like) or may be by merchant (i.e., only certain stores). In some embodiments, the locations are by type of store. For instance, the PIN may only allow transactions at a type of store that includes grocery stores. In embodiments, the item limits include the PIN restricting access to funds from the account to only set items. The items may include any item that may be accessed by funds such as, without limitation, grocery items, household items, and the like. In some embodiments, the items may be restricted by type of item and by brand of item. Restricting access to the account for certain items may be accomplished by any desirable method. In an embodiment, such method includes restricting access to account funds to items having set stock-keeping units (SKU). It is to be understood that SKU refers to a number or code that is used to identify a unique item. In embodiments, approved SKUs are entered into a database, which is accessed by the system. Any SKU not in the database is not allowed to be purchased by use of the PIN. Time termination limits include set time durations after which the PIN is no longer valid. For instance, a PIN may be set to only be valid for 10 days. In some embodiments, the PIN may be set to only be valid for a period of time in certain locations. For instance, a PIN may only be valid for five days when used in Mexico. Access termination limits include setting a maximum number of times at which the PIN may be used in a period of time before access to the account is permanently terminated or temporarily terminated. In some embodiments, incorrect PIN termination limits include a maximum amount of times a PIN may be entered incorrectly in a period of time before access to the account is permanently terminated or temporarily terminated. FIG. 5 illustrates an embodiment of an example of PIN at account level system 5 in which a financial account 30 has more than one PIN and also has more than one restriction. As shown, PIN at account level system 5 has account 30 with first PIN 15, second PIN 20, and third PIN 25. First pin 15 has restriction 75 and restriction 80; second pin 20 has restriction 85, restriction 90, and restriction 95; and third pin 25 has restriction 100. Restriction 75, restriction 80, restriction 85, restriction 90, restriction 95, and restriction 100 are different restrictions or at least one of such restrictions is the same as another restriction.

In embodiments in which an account has more than one PIN associated with the account, PIN at account level system 5 includes that each PIN may also have access to the transaction history and/or totals of the account associated with that PIN but not have access to such information of account associated with the other PINs associated with the account. In some embodiments, each PIN may provide a user the ability to change the PIN of only that PIN but not the other PINs associated with the account. In embodiments, the PIN may be changed in real-time.

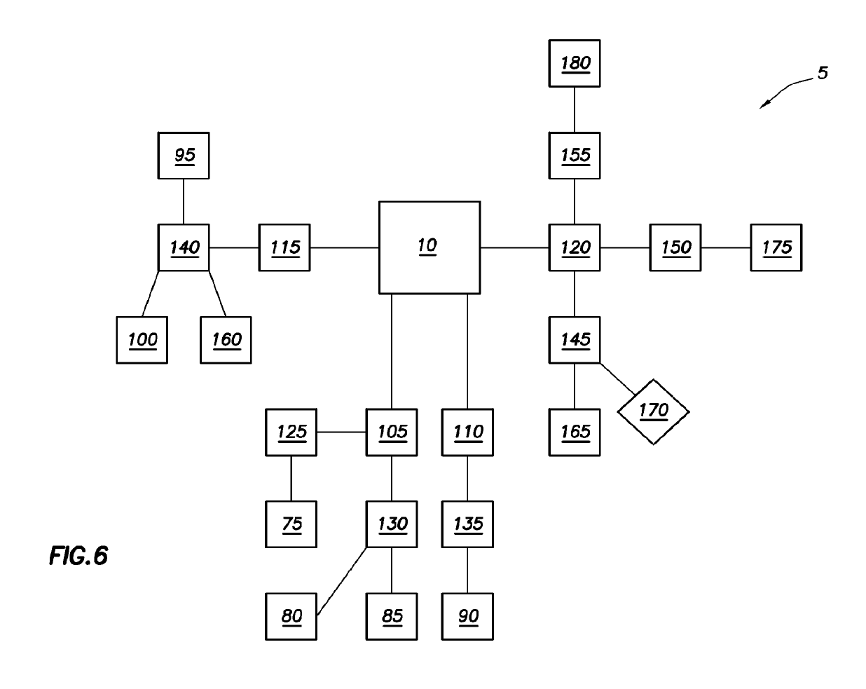

In an embodiment, PIN at account level system 5 includes multiple copies of the same card. In such an embodiment, one or more than one of the copies of the card have a different PIN or PINs. Each different PIN may provide a different restriction or restrictions. FIG. 6 illustrates an example of such an embodiment in which card 10 has card copy 105, card copy 110, card copy 115, and card copy 120. Card copy 105 has PIN 125 and PIN 130; card copy 110 has PIN 135; card copy 115 has PIN 140; and card copy 120 has PIN 145, PIN 150, and PIN 155. PIN 125 has restriction 75; PIN 130 has restriction 80 and restriction 85; PIN 135 has restriction 90; PIN 140 has restriction 95, restriction 100, and restriction 160; PIN 145 has restriction 165 and restriction 170; PIN 150 has restriction 175; and PIN 155 has restriction 180.

In an embodiment, PIN at account level system 5 has a master PIN for each account. In embodiments, the master PIN allows access to and control over one or more than one other PIN associated with an account. In some embodiments, the master PIN allows access to and control over all of the PINs associated with an account. In some embodiments, the master PIN has control over more than one account and the PINs associated with such accounts. For instance, the master PIN allows account balances, transactions, and the like to be accessed. The master PIN also allows the user of the master PIN to access and change the restrictions and PINs on an account. The master PIN may change the PINs and also allow the master PIN to be changed in real-time.

In embodiments, PIN at account level system 5 does not have a human interface for changing a PIN and/or restrictions. Without limitation, the lack of a human interface is for security purposes. It is to be understood that lack of a human interface refers to a user not being able to verbally or through written communication authorize another human to change a PIN and/or restriction. In such embodiments, such change may only be through electronic devices. The electronic devices may include any electronic device suitable for electronically accessing information and/or communicating information. Without limitation, examples of electronic devices are computers, cellular phones, and the like. In embodiments, to change a PIN, the user inputs the PIN via an electronic device, and PIN at account level system 5 authenticates the PIN. The user then through the proper prompts instructs PIN at account level system 5 to change the device PIN. The user may then select the desired new PIN.

In some embodiments, PIN at account level system 5 determines the strength of a PIN. PIN at account level system 5 may use any method suitable for determining the strength of a PIN such as logic. In embodiments, the logic determines the randomness of a PIN. In an embodiment, PIN at account level system 5 indicates to the user and/or the user of the master PIN the strength of the PIN. In some embodiments, PIN at account level system 5 provides a minimum threshold by which the strength of the PIN must achieve before being allowed. In embodiments, the threshold is set by the user of the master PIN. In some embodiments, a risk threshold may be assigned at which any PIN below such threshold passes the risk of an improper transaction (i.e., theft) off to the user of the PIN. In some embodiments, multiple risk thresholds are assigned to a PIN, at which each risk threshold passes a different percentage of risk to the user of the PIN. In embodiments, PIN at account level system 5 does not allow identical PINs. Each PIN is different from all other PINs.

Although the present invention and its advantages have been described in detail, it should be understood that various changes, substitutions and alterations may be made herein without departing from the spirit and scope of the invention as defined by the appended claims.

What is claimed is:

1. A PIN at account level system, comprising:
a PIN assigned to a financial account, wherein the PIN is different from a PIN of another financial account; and
wherein the system allows access to the financial account by confirmation of the PIN assigned to the financial account when the PIN is provided.

2. The PIN at account level system of claim 1, wherein the PIN comprises a number, a letter, a punctuation mark, a symbol, or any combinations thereof.

3. The PIN at account level system of claim 1, further comprising a card linked to the financial account, wherein the PIN allows access to the financial account by the card.

4. The PIN at account level system of claim 3, wherein the card comprises a physical card or a virtual card.

5. The PIN at account level system of claim 3, wherein the card comprises a combi-card linked to at least one additional financial account.

6. The PIN at account level system of claim 5, wherein each financial account has a PIN that is different from the PIN of another financial account.

7. The PIN at account level system of claim 3, wherein the card has more than one PIN associated with the card and that which is associated with the financial account.

8. The PIN at account level system of claim 7, wherein the financial account comprises a true balance, and wherein a first PIN provides access to the true balance for the financial account.

9. The PIN at account level system of claim 8, wherein another PIN provides access to a different balance for the financial account from that of the true balance.

10. The PIN at account level system of claim 8, wherein another PIN provides a duress signal.

11. The PIN at account level system of claim 3, further comprising multiple copies of the card.

12. The PIN at account level system of claim 1, further comprising more than one PIN assigned to the financial account.

13. The PIN at account level system of claim 12, wherein each PIN comprises a different transaction limit.

14. The PIN at account level system of claim 12, wherein at least one of the PINs has a restriction.

15. The PIN at account level system of claim 14, wherein the restriction comprises a daily withdrawal limit, a maximum point of sale limit, a maximum daily limit, a maximum withdrawal and/or point of sale limit over a period of time, a location limit, an item limit, a time termination limit, an access termination limit, an incorrect PIN termination limit, or any combinations thereof.

16. The PIN at account level system of claim 15, wherein the daily withdrawal limit comprises a maximum amount of cash allowed to be withdrawn per day.

17. The PIN at account level system of claim 15, wherein the maximum point of sale limit comprises a maximum amount that may be withdrawn at a point of sale.

18. The PIN at account level system of claim 15, wherein the location limit comprises a restriction to access to the financial account to an allowed geographical area.

19. The PIN at account level system of claim 15, wherein the item limit comprises the PIN restricting access to funds of the financial account to only an allowed item.

20. The PIN at account level system of claim 1, further comprising a master PIN.
